(19) United States
(12) Patent Application Publication
(10) Pub. No.: US 2010/0303568 A1
(43) Pub. Date: Dec. 2, 2010

(54) Drill bit system, assembly, and method for forming holes in materials

(76) Inventor: Colleen York, Algonquin, IL (US)

Correspondence Address: Meroni & Meroni, P.C., P.O. Box 309, Barrington, IL, 60011, US

(21) Appl. No.: 12/660,361

(22) Filed: Feb. 25, 2010

Related U.S. Application Data
(60) Provisional application No. 61/182,855, filed on Jun. 1, 2009.

(51) Int. Cl. B23B 27/16; B23B 51/02; B23B 35/00

(52) U.S. Cl. 408/1 BD; 408/21; 408/226

(57) ABSTRACT

A drill bit system, assembly, and method enables a user to quickly and easily interchange drill bits upon a shank during drilling operations. The drill bit system comprises an elongate shank, a series of drill bits, and a set screw. The shank has a notched, bit-engaging end. Each drill bit has a shank-engaging end and a bit axis. Each shank-engaging end has inner female structure for receiving the bit-engaging end and a threaded aperture. Each threaded aperture respectively extends from the inner female structure orthogonally relative to the bit axis, and each female structure has a substantially uniform inner bit diameter sized for receiving the shank. The bit-engaging end is receivable by the shank-engaging ends, and the set screw is threadably receivable by both the threaded apertures and the notch for removably and interchangeably fastening the drill bits to the shank.

### PRIOR HISTORY

This application claims the benefit of U.S. Provisional Patent Application No. 61/182,855, filed in the United States Patent and Trademark Office on Jun. 1, 2009.

### BACKGROUND OF THE INVENTION

1. Field of the Invention

The present invention generally relates to a drill bit assembly for forming holes in and installing lines in structural members. More particularly, the present invention relates to a drill bit assembly configured for quick and easy interchangeability of drill bits upon a single, elongate, flexible shank.

2. Description of Prior Art

U.S. Pat. No. 597,750 ('750 patent), which issued to Smith, discloses an Auger Bit. The '750 patent describes a bit or auger for use in wiring buildings, composing a shank and head, the head being of greater diameter than the shank throughout its length, and being provided with two spiral grooves which extend throughout its length with two spiral grooves which extend throughout its length, from the smaller diameter of the shank adjacent to the head to the cutting point and a plurality of transverse perforations or openings formed in the head, by which said grooves are connected, substantially as shown and described.

U.S. Pat. No. 2,958,349 ('349 patent), which issued to McNutt, discloses a Curved Extension Drill. The '349 patent describes a tubular outer sleeve which is bent intermediate its ends, a bit within it lower straight portion, an inner sleeve bearing slidably mounted in the upper straight portion, and a flexible shaft connecting the bit and the slidable bearing. The straight portions of the sleeve define an included angle of approximately 135 degrees. The lower end of the outer sleeve is notched for chip clearance. The bit shank is rotatably and slidably received in a bearing located in the lower end of the sleeve immediately above the recess.

As shown in FIG. 2 of the '349 patent, the bearing is detachably secured in place by means of a set screw threadably engaged in and extending through the sleeve and into a recess in the side of the bearing. The shank of the bit is connected with the lower end of the flexible shaft by means of a set screw threadably positioned through the side of the tubular adapter, the outside diameter of said adapter being slightly less than the inside diameter of said sleeve, and which set screw extends into a recess in the upper end of said bit shank which is slidably received within said tubular adapter. The set screw is accessible through an opening in the side of the sleeve.

U.S. Pat. No. 3,611,549 ('549 patent), which issued to Pope, discloses a Method for Forming Holes in and Installing Lines in Structural Members. The '549 patent describes a method for forming holes for electrical conductor lines and the like in structural frame members of a hollow wall by utilizing a drill having an elongate spring-like shaft with a drill bit on its leading end. The shaft may be bowed to insert the same into the all to direct the drill bit in the desired direction.

U.S. Pat. No. 3,915,245 ('245 patent), which issued to Tuccillo, discloses a Test Boring Drill Bit. The '245 patent describes the ball which is removed from the tubular coring device of FIG. 1 and a bit attached to the coring device by means of the set screw making sure that the handle is in a position of vertical to right of vertical as shown in position A of FIG. 8. The assembly is connected to the drill pipe and lowered to drilling elevation. The drilling fluid is connected to the top of the drill pipe and drilling is started.

U.S. Pat. No. 4,033,703 ('703 patent), which issued to Slater, discloses a Drill Bit for Coupling to a Wire Fishing Adapter. The '703 patent describes a drill adapted to be detachably and pivotably linked to a wire fishing adapter for pulling wiring through a bored-out passage in a wall or the like, including a blade-type drill bit having a pin protruding from one of the faces of the drill bit blade, a rod having a pair of spaced-apart apertured fingers at one end and having a conically-shaped receptacle at the opposite end for lockable engagement with the end of a wire.

U.S. Pat. No. 7,131,790 ('790 patent), which issued to Cordoves, discloses a Boring and Conduit/Pipe System. The '790 patent describes an extension rod having an interior end and an exterior end. The exterior end is formed with male screw threads. A primary bit has a cylindrical interior end and a conical exterior. Female threads at the interior end releasably couple with the extension rod. A secondary bit has a cylindrical interior end and a conical exterior end. Female threads at the interior end releasably couple with the extension rod. A length of line is coupled to the exterior end of the secondary bit. A coupler has a rearward end couplable to a linear member. A forward end is couplable to the rearward end of the secondary bit. In this manner the line, secondary bit and linear member may be pulled through the bore hole.

U.S. Pat. No. 7,435,042 ('042 patent), which issued to White et al., discloses a Flexible and Extendable Drill Bit Assembly. The '042 patent describes a flexible, extendable extension assembly used to create extended length holes and holes through inaccessible areas in walls and framing. The extension assembly including a flexible rod having first and second ends; and a holding means secured to the first end of the rod for releasably holding a tool bit for rotation with the rod.

It will thus be seen that holes for electrical conductor lines and the like through structural members are commonly drilled using an apparatus consisting of a specialized drill bit fastened to a spring steel shank. Due to the diversity of building materials a worker encounters and the many different length requirements in a construction project, a worker must purchase several different styles and lengths of elongate drill bits, which can be very costly.

Certain attempts have been made and several products currently exist that have an interchangeable bit but due to the diameter of their connecting device these devices can only be used with large ¾ inch or larger bits and ¼ inch shanks. In addition, some have been introduced with a connection consisting of an internal and external thread to join the drill bit and the shank together. This application is not feasible due to the operation of the apparatus requires in some cases to operate in reverse, causing the drill bit to unthread and become lost in the wall.

The prior art thus perceives a need for an improved drill bit assembly having interchangeable drill bits of several types and sizes specially manufactured with a threaded hole accepting a set screw at a right angle to the tapered portion of the shank of the drill bit and a specially manufactured spring steel shank with a groove to accept the set screw passing through the drill bit shank that would allow for the use of all diameters (⅜ inch to 1 inch bits), all types (wood, steel, and masonry bits), and 3/16 inch and ¼ inch spring steel shanks, as described in more detail hereinafter.

### SUMMARY OF THE INVENTION

The present invention essentially provides an improvement to state of the art drill bit assemblies for drilling holes in structural members whereby an elongate shank is notched or grooved at one end and is received in female structure of specially formed drill bits, each of which comprise a set screw-receiving aperture formed at right angles to the axes of the bits. A set screw is the threadably receivable in the set screw-receiving apertures and the notched end of the shank for enabling the user to quickly and easily interchange drill bits upon the elongate shank.

### BRIEF DESCRIPTION OF THE DRAWINGS

Other features of my invention will become more evident from a consideration of the following brief description of patent drawings:

FIG. 1 is an exploded side view of a fragmentary shank, a first drill bit, and a set screw according to the present invention.

FIG. 2 is a side view of a fragmentary shank, a second drill bit, and a set screw as assembled according to the present invention.

FIG. 3 is an enlarged fragmentary view of a shank-engaging end of a drill bit according to the present invention showing orthogonal female structure for receiving a bit-engaging end and a set screw.

FIG. 4 is an enlarged fragmentary view of a bit-engaging end of a shank and a set screw inserted into the shank-engaging end otherwise shown in FIG. 3.

FIG. 4(a) is an enlarged fragmentary perspective view of a set screw exploded from a shank-engaging end of a drill bit according to the present invention.

FIG. 5 is an exploded side view of a third drill bit and a set screw according to the present invention.

FIG. 6 is an exploded side view of a fourth drill bit and a set screw according to the present invention.

FIG. 7 is an exploded side view of a fifth drill bit and a set screw according to the present invention.

FIG. 8 is a side view type depiction of the drill bit assembly according to the present invention outfitted with a first drill bit for drilling wood drilling through a fragmentary wooden structure.

FIG. 9 is a side view depiction of the first drill bit otherwise shown in FIG. 6 being interchanged with a second drill bit for drilling through masonry.

FIG. 10 is a side view depiction of the drill bit assembly according to the present invention outfitted with the second drill bit otherwise shown in FIG. 7 drilling through a fragmentary masonry structure.

FIG. 11 is a side perspective type depiction of the drill bit assembly according to the present invention drilling through a series of structural members as juxtaposed adjacent a prior art adapter assembly drilling through a first of the structural members.

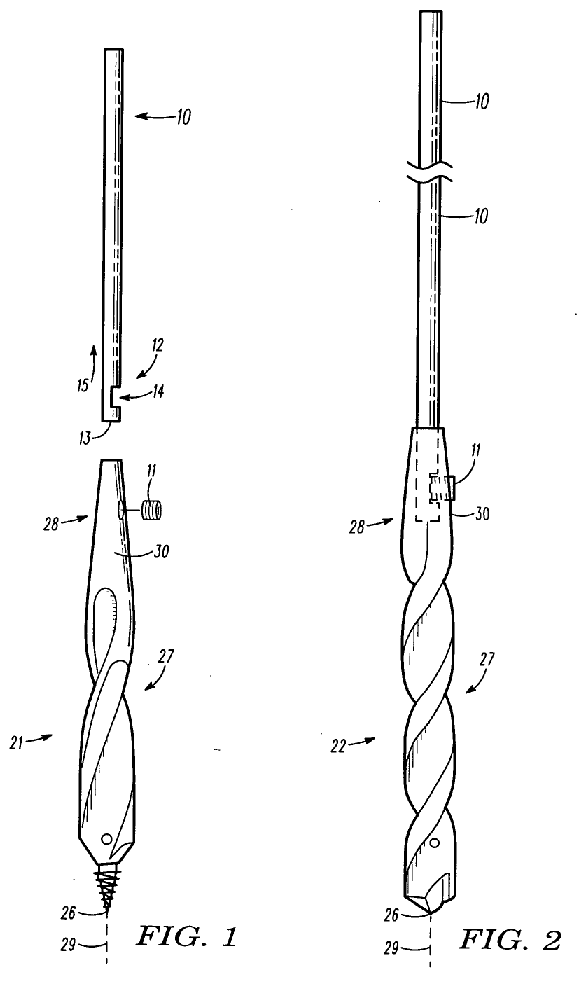

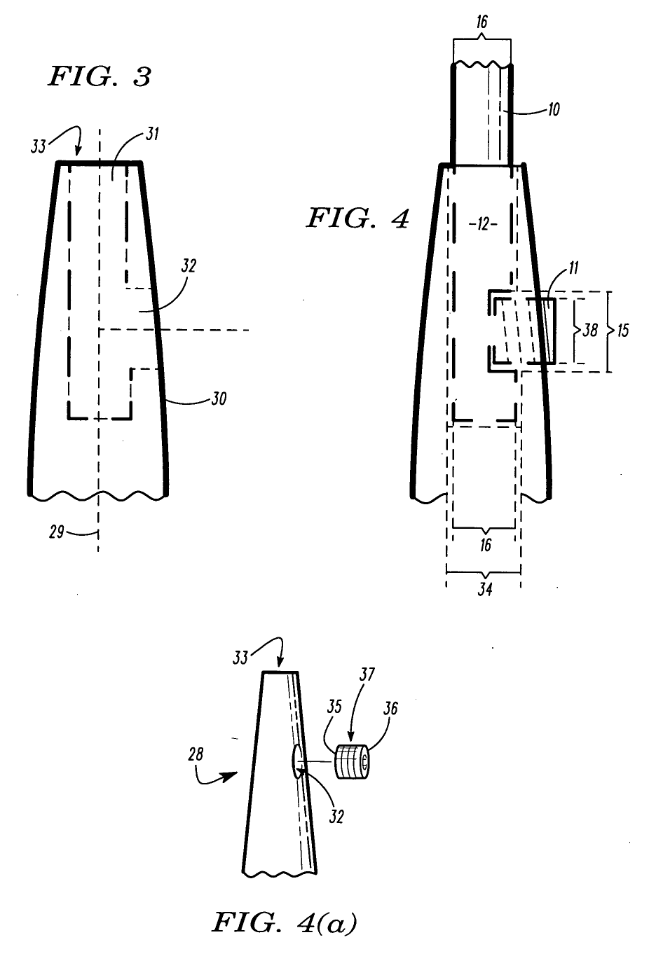

### DETAILED DESCRIPTION OF THE PREFERRED EMBODIMENT(S)

Referring now to the drawings with more specificity, the present invention essentially provides a drill bit system for enabling a user to quickly and easily interchange drill bits upon a flexible shank during drilling operations. It is noted that during drilling operations, a worker will often encounter layered or adjacent structures of differing materials through which a bore hole must be formed. State of the art flexible drill bits are commonly of integral construction rendering the interchangeability of drill bits cumbersome and costly.

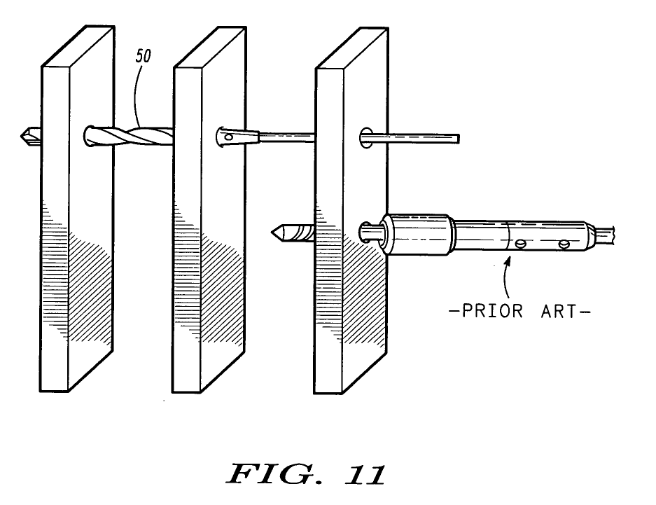

Further, prior art adapter assemblies, such as the adapter assembly shown in U.S. Pat. No. 7,435,042 (and generally depicted in FIG. 11 juxtaposed adjacent a drill bit assembly 50 according to the present invention) typically comprise outer diameters that are too large to pass through smaller diameter holes. Larger diameter drill bits have to be used in order for these types of adapters to be useful as may be gleaned from an inspection of FIG. 11.

In other words, adapters on the market today can only be used with a ¾ inch and larger drill bits limiting the adapter's usefulness, since most building codes require a much smaller hole (⅜ inch to 9/16 inch) for installing the most common cable. A noted further problem with adapters is that when adapters of the type shown in FIG. 11 rotate at high speeds inside blind areas, they tend to release the drill bit inside the wall. Constructing the drill bits in such a way as to incorporate the adapter into the shank of the drill bit assembly allows any drill bit size (⅜ inch and larger) to be used.

In an attempt to remedy the problems commonly associated with state of the art flexible drill bits, the drill bit system according to the present invention preferably comprises, in combination, an elongate shank 10, a series of interchangeable drill bits, and a set screw 11. The shank 10 has a bit-engaging end 12, which bit-engaging end 12 comprises a shank tip 13, a notched portion 14 adjacent the shank tip 13, and a shank length 15 extending from the notched portion 14. The shank tip 13 and shank length 15 have a substantially uniform outer shank diameter as at 16, and the notched portion 14 has a substantially uniform notch width as at 17.

It is contemplated that any number of drill bits may be specifically manufactured to meet the specifications of the present invention. In this regard, the drawings show a screw point drill bit as at 21, a high speed drill bit as at 22, a masonry drill bit as at 23, a wood drill bit as at 24, and an auger type drill bit as at 25. Each drill bit according to the present invention has a bit tip 26, a flute portion 27, a shank-engaging end 28, and a bit axis 29.

Each shank-engaging end 28 comprises a (tapered) outer bit surface 30, an inner female structure 31 for receiving the bit-engaging end 12, a threaded aperture 32, and a shank-receiving mouth 33. Each threaded aperture 32 respectively extends from the outer bit surface 30 to the inner female structure 31 orthogonally relative to the bit axis 29 as generally depicted in FIG. 4. Each female structure 31 has a substantially uniform inner bit diameter 34 sized for receiving the outer shaft diameter 16.

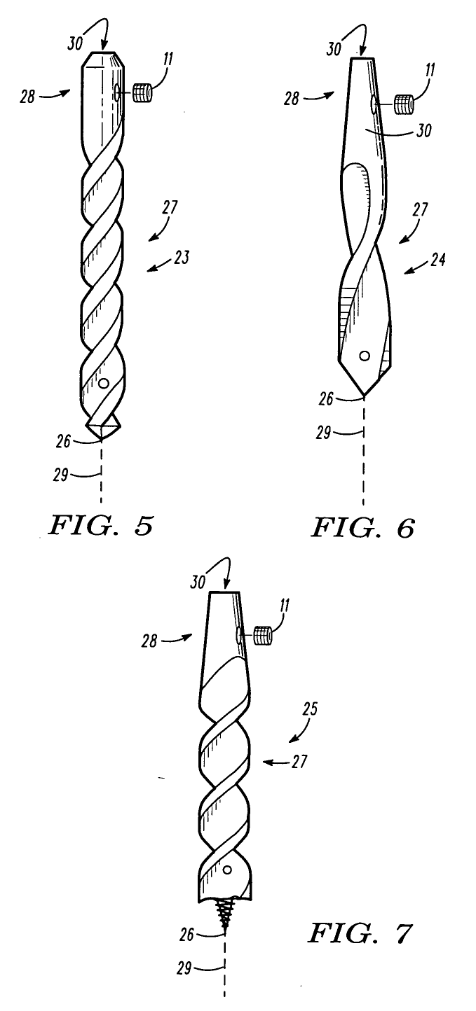

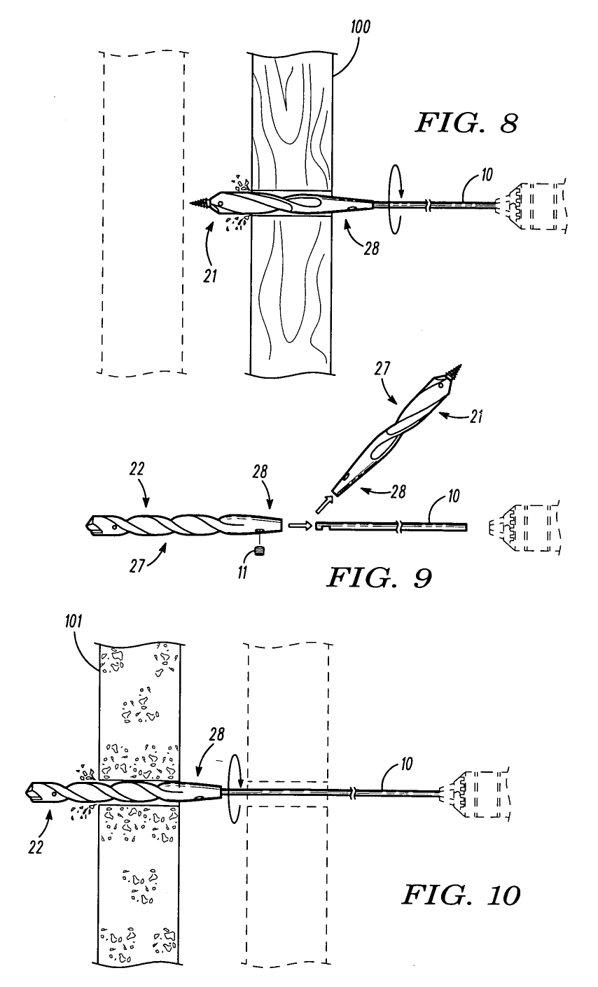

The set screw 11 removably and interchangeably fastens the drill bits to the shank 10, and has a notch-engaging end 35, a tool-engaging end 36, and a threaded body 37 extending intermediate the notch-engaging and tool-engaging ends 35 and 36. The threaded body 37 has a maximal screw diameter as at 38. Notably, the notch width 15 is sized for receiving the maximal screw diameter 38 as generally depicted in FIG. 5. The bit-engaging end 12 being receivable by the shank-engaging end(s) 28, and the set screw 11 is threadably receivable by the threaded aperture(s) 32.

While the above description contains much specificity, this specificity should not be construed as limitations on the scope of the invention, but rather as an exemplification of the invention. For example, it is contemplated that the present invention essentially provides a drill bit assembly comprising a shank, at least one primary drill bit, and certain means for removably fastening the drill bit to the shank, as preferably defined by a set screw.

The shank has a bit-engaging end, which bit-engaging end comprises a shank tip, a notched portion adjacent the shank tip, and an elongate shank length extending from the notched portion. The shank tip and shank length have a substantially uniform outer shank diameter, and the notched portion has a substantially uniform notch width.

The primary dill bit has a bit tip, a flute portion, a shank-engaging end, and a bit axis. The shank-engaging end has an outer bit surface, an inner female structure for receiving the bit-engaging end, a threaded bit aperture, and a shank-receiving mouth. The threaded bit aperture extends from the outer bit surface to the inner female structure orthogonally relative to the bit axis. The female structure has a substantially uniform inner bit diameter sized for receiving the outer shaft diameter.

The means for removably fastening the drill bit to the shank or set screw has a notch-engaging end, a tool-engaging end, and a threaded body extending intermediate the notch-engaging and tool-engaging ends. The threaded body has a maximal screw diameter. The notch width is sized for receiving the maximal screw diameter. The bit-engaging end is received by the primary shank-engaging end. The set screw is threadably received by the threaded aperture, and the notch-engaging end is received by the notch.

The foregoing specifications are further believed to support certain methodology for forming holes in a plurality of materials. The method may be said to comprise the initial steps of forming or providing a shank with a notched, bit-engaging end, the notch of which end has a substantially uniform notch width; and forming or providing a series of drill bits, each of which has a shank-engaging end with inner female structure for receiving the bit-engaging end and a threaded aperture for receiving a set screw.

A first set screw is threadably inserted into a first threaded aperture of a first shank-engaging end of a first drill bit, which first set screw has a maximal outer first screw diameter. The bit-engaging end is inserted into the first shank-engaging end thereby joining the first drill bit to the shank. The first set screw is extended into the notch of the bit-engaging end such that the maximal outer first screw diameter is received intermediate the notch width as generally depicted in FIG. 5.

Once the first set screw is extended into the notch, it may be tightened against the bit-engaging end thereby removably fastening the first drill bit to the shank. Once the first drill bit is fastened to the bit-engaging end, the first drill bit may be used to drill through a first material, such as wood as at 100.

Notably, constructing the shank 10 with a notch 14 or groove instead of a flat allows for retrieval of the drill bit even if the set screw 11 becomes inadvertently loosened from the bit-engaging end 12. In other words, the depth of the notch 14 relative to the outer surface of the bit-engaging end 12 provides certain stop structure such that when the set screw 11 extends into the notch, the body 37 may still function to engage the bit-engaging end 12 in a direction parallel to the axis of the shank 10.

The method may be said to comprise the further steps of intentionally loosening the first set screw from the bit-engaging end for releasing the first shank-engaging end from the bit-engaging end; withdrawing the first set screw from the notch; and withdrawing the first shank-engaging end from the bit-engaging end, thereby removing the first drill bit from the shank. The first set screw may then be threadably removed from the first threaded aperture thereby releasing the first set screw from the first shank-engaging end.

Further, the method may comprise the steps of threadably inserting the first set screw into a second threaded aperture of the second drill bit; inserting the bit-engaging end into the second shank-engaging end thereby joining the second drill bit to the shank; re-extending the first set screw into the notch of the bit-engaging end; re-tightening the first set screw against the bit-engaging end thereby removably fastening the second drill bit to the shank; and drilling through a second material, such as masonry as at 101.

Accordingly, although the invention has been described by reference to certain preferred and alternative embodiments, and certain methodology, it is not intended that the novel disclosures herein presented be limited thereby, but that modifications thereof are intended to be included as falling within the broad scope and spirit of the foregoing disclosure, the following claims and the appended drawings.

I claim:

1. A drill bit system for enabling a user to quickly and easily interchange drill bits upon a shank during drilling operations, the drill bit system comprising:
a shank, the shank having a bit-engaging end, the bit-engaging end having a shank tip, a notched portion adjacent the shank tip, and a shank length extending from the notched portion, the shank tip and shank length having a substantially uniform shank diameter, the notched portion having a substantially uniform notch width;
at least two drill bits, each drill bit having a bit tip, a flute portion, a shank-engaging end, and a bit axis, each shank-engaging end having an outer bit surface, an inner female structure for receiving the bit-engaging end, a threaded aperture, and a shank-receiving mouth, each threaded aperture respectively extending from the outer bit surface to the inner female structure orthogonally relative to the bit axis, each female structure having a substantially uniform inner bit diameter sized for receiving the shank diameter; and
a set screw, the set screw having a notch-engaging end, a tool-engaging end, and a threaded body extending intermediate the notch-engaging and tool-engaging ends, the threaded body having a maximal screw diameter, the notch width being sized for receiving the maximal screw diameter, the bit-engaging end being receivable by the shank-engaging ends, the set screw being threadably receivable by the threaded apertures, the notch-engaging end being receivable by the notch, the set screw thus for removably and interchangeably fastening the drill bits to the shank.

2. A drill bit assembly, the drill bit assembly comprising:
a shank, the shank having a bit-engaging end, the bit-engaging end having a shank tip, a notched portion adjacent the shank tip, and a shank length extending from the notched portion, the shank tip and shank length having a substantially uniform shank diameter, the notched portion having a substantially uniform notch width;
a primary drill bit, the primary dill bit having a primary shank-engaging end and a primary bit axis, the primary shank-engaging end comprising an outer bit surface, an inner female structure for receiving the bit-engaging end, and a bit aperture, the bit aperture extending from the outer bit surface to the inner female structure orthogonally relative to the bit axis, the female structure having a substantially uniform inner bit diameter sized for receiving the shaft diameter; and
fastening means for removably fastening the primary drill bit to the shank via the notch, the notch width being sized for receiving said fastening means, the bit-engaging end being receivable by the primary shank-engaging end, said fastening means being receivable by and cooperable with the bit aperture and the notch for removably fastening the primary drill bit to the shank.

3. The drill bit assembly of claim 2 usable in combination with at least one secondary drill bit, the secondary drill bit having secondary bit tip, a secondary flute portion, a secondary shank-engaging end, and a secondary bit axis, the primary and secondary shank-engaging ends being substantially identical for enabling the user to quickly interchange the primary and secondary drill bits upon the shank via said fastening means during drilling operations.

4. A method for forming holes in a plurality of materials; the method comprising the steps of:
providing a shank with a bit-engaging end, the bit-engaging end having fastener-receiving structure, the fastener-receiving structure having a structural width;
providing a series of drill bits, each drill bit having a shank-engaging end with inner female structure for receiving the bit-engaging end and an aperture for receiving a fastener;
inserting a first fastener into a first aperture of a first shank-engaging end of a first drill bit, the first fastener having a maximal outer first fastener diameter;
inserting the bit-engaging end into the first shank-engaging end thereby joining the first drill bit to the shank;
extending the first fastener into the fastener-receiving structure of the bit-engaging end such that the maximal outer first fastener diameter is received intermediate the structural width;
fastening the first drill bit to the shank via fastening engagement of the first fastener against the bit-engaging and first shank-engaging ends; and
drilling through a first material via the first drill bit.

5. The method of claim 4 comprising the steps of
unfastening the first fastener from the bit-engaging and shank-engaging ends for releasing the first shank-engaging end from bit-engaging end;
withdrawing the first fastener from the fastener-receiving structure; and
withdrawing the first shank-engaging end from the bit-engaging end, thereby removing the first drill bit from the shank.

6. The method of claim 5 comprising the steps of removing the first fastener from the first aperture thereby releasing the first fastener from the first shank-engaging end.

7. The method of claim 6 comprising the steps of:
inserting the first fastener into a second aperture of a second shank-engaging end of a second drill bit;
inserting the bit-engaging end into the second shank-engaging end thereby joining the second drill bit to the shank;
re-extending the first fastener into the fastener-receiving structure of the bit-engaging end;
fastening the second drill bit to the shank via fastening engagement of the first fastener against the bit-engaging and the second shank-engaging ends; and
drilling through a second material via the second drill bit.

8. The method of claim 5 comprising the steps of:
inserting a second fastener into a second aperture of a second shank-engaging end of a second drill bit;
inserting the bit-engaging end into a second shank-engaging end thereby joining the second drill bit to the shank;
extending the second fastener into the fastener-receiving structure of the bit-engaging end;
fastening the second drill bit to the shank via fastening engagement of the second fastener against the bit-engaging and the second shank-engaging ends; and
drilling through a second material via the second drill bit.

9. The method of claim 8 comprising the steps of
unfastening the second fastener from the bit-engaging end for releasing the second shank-engaging end from bit-engaging end;
withdrawing the second fastener from the fastener-receiving structure; and
withdrawing the second shank-engaging end from the bit-engaging end, thereby removing the second drill bit from the shank.

10. The method of claim 9 comprising the steps of removing the second fastener from the second aperture thereby releasing the second fastener from the second shank-engaging end.
